(19) United States
(12) Patent Application Publication
(10) Pub. No.: US 2004/0157204 A1
(43) Pub. Date: Aug. 12, 2004

(54) Electronic learning aid having a removable game module

(76) Inventor: Nick Griffin, Surrey (GB)

Correspondence Address: Howard E. Silverman, LAW OFFICES OF DICK & HARRIS, Suite 3800, 181 W. Madison Street, Chicago, IL, 60602, US

(21) Appl. No.: 10/361,874

(22) Filed: Feb. 10, 2003

(51) Int. Cl. G09B 25/00

(52) U.S. Cl. 434/365

(57) ABSTRACT

An electronic learning aid device which includes a removable module including display and input controls, capable of operating, independent of the electronic learning aid apparatus towards extending the functionality of the device and encouraging it's continued use. A first set of activities is accessible to the operator when the removable module is in its installed configuration and a second set of activities is accessible to the operator when the removable module is in its uninstalled configuration.

### BACKGROUND OF THE INVENTION

1. Field of the Invention

The present invention relates to electronic learning aid devices and electronic games incorporating visual displays and user input devices. More specifically, the present invention relates to an electronic learning aid device, which includes a removable module including display and input controls, capable of operating, independent the electronic learning aid towards extending the functionality of the device and encouraging it's continued use.

2. Prior Art

Various forms of electronic teaching devices such as electronic learning aids are known in the art. One example of a prior art electronic learning aid comprises a battery operated tabletop device resembling a full function laptop personal computer having an overall clamshell appearance. Such prior art electronic learning aid devices typically include a display screen, such as an LCD, positioned on the inside surface of the lid or cover, and a user input device, such as a keyboard, positioned on the inside surface of the lower portion or base of the unit. Typically contained within the housing are batteries for providing electrical power to the device, and the various circuits required to operate the device including a microprocessor and computer memory and, in some cases, a voice synthesizer for generating requests and/or responses to the user in synthesized human speech. These types of devices are typically targeted to children ranging from four years of age up through high school age. The content of such electronic learning aid devices typically include programming for teaching various subjects, appropriate for one or more specific age groups, and often include spelling, math, history, science and other subjects.

The aforementioned prior art electronic learning aid devices when in their closed clamshell configuration typically measure approximately twelve inches by nine inches by two inches. While portable, given the internal battery supply, these devices are typically used in the home and or school and are typically not transported by the user from place to place.

These devices have found great use in the home and in the school, as they are primarily directed to teaching various “school subjects” to children or to otherwise reinforcing the subjects taught at school. In an effort to entice children to use and keep using such educational devices, prior art devices typically include some form of entertainment play such as games or puzzles since children prefer playing games to learning core school subjects in a dry question and answer format. However, there always remains the potential for the child to use only the entertainment activities and games included in the device and disregard the educational activities and content.

Another category of portable electronic devices which have become almost commonplace are a class of products known as portable handheld game devices and include, for example, a handheld entertainment gaming system known by the trademark Gameboy, manufactured and sold by Nintendo Corporation. These types of devices are almost exclusively directed to children and, in contrast to the primarily educational content of electronic learning aid devices, focus almost exclusively on pure entertainment and games. While typically lacking a keyboard input device, a portable handheld game device typically includes a display such as an LCD and one or more input mechanisms comprising buttons and/or rocker switches which are used to operate the device and play a given game. A portable handheld game device commonly measures six inches by four inches by less than one inch thick and given its relatively small size is very portable and very attractive to young school age children who often do not hesitate to pack one along with their school books and/or readily carry such game unit out of the house and to a friend's home for play.

While an electronic learning aid device is certainly portable, it is typically less likely to be taken by the child from the home or school. Moreover, the electronic learning aid serves primarily as an educational device and not an entertainment device and accordingly may be set aside by the child in favor of the portable handheld game device. Given the parent's desire to provide the best educational learning environment for the child, as well as the child's desire to have as many games to play as possible, it is not uncommon to find households who have purchased both electronic learning aid devices and portable handheld game units to satisfy the demands and desires of both parent and child. This results in a household incurring a potentially unnecessary expense given that the technology for implementing an electronic learning aid device is not all that dissimilar from the technology used to implement a portable handheld game device, but, given the common technology separate stand-alone devices remain the norm.

Accordingly, it is an object of the present invention to provide a single portable device, which may serve as both a tabletop electronic educational learning aid as well as a portable handheld entertainment device.

It is another object of the present invention to forego having to purchase two separate devices having technology so closely related to one another.

It is a further object of the present invention to provide an electronic learning aid device that includes a removable module, which may function on a stand-alone basis as a portable handheld game device.

It is yet another object of the present invention to provide an electronic learning aid device which includes a removable handheld game device which serves to attract a child's attention and promote continued and extensive use of the device in both learning and entertainment capacities thereby maximizing the value and utility of same.

It is a further object of the present invention to provide for game activities to become accessible to the user only upon the user having accessed and used the educational activities for a particular amount of time and/or having achieved a particular proficiency in one or more of the various subject matters presented by the educational activities.

It is still another object of the present invention to provide for game activities to acquire increased functionality and characters therein to acquire increased performance capabilities in the context of associated games as the educational activities are used by the child.

These and other objects of the present invention will become apparent in light of the present specification, drawings and claims.

### SUMMARY OF THE INVENTION

The present invention comprises, in part, a dual purpose electronic educational entertainment apparatus, having a base unit having at least one user input device and a removable unit having at least one user input device and a visual display device. The base unit further includes a receptacle for the removable receipt of the removable unit towards the base unit and removable unit operating together as a unit when the removable unit is in its installed configuration and wherein the removable member may operate separate and independent of the base member when the removable unit is in its uninstalled configuration. In the preferred embodiment of the present invention a first set of activities are accessible to the operator when the removable unit is in its installed configuration and a second set of activities are accessible to the operator when the removable unit is in its uninstalled configuration. In another embodiment, an electronic educational entertainment apparatus for presenting to a child both educational activities and entertainment activities, comprises a base unit having at least one user input device; a removable unit having at least one user input device and a visual display device, wherein the base unit further includes a receptacle for accepting receipt of the removable unit towards the base unit and removable unit operating together as a unit when the removable unit is in its installed configuration for presenting primarily educational activities to the child and the removable unit operating independent of the base unit when the removable unit is in its uninstalled configuration for presenting primarily entertainment activities to the child.

### BRIEF DESCRIPTION OF THE DRAWINGS

FIG. 1 of the drawings is a top plan view of the dual purpose electronic learning aid apparatus of the present invention;

FIG. 2 of the drawings is a left side elevational view of the present invention in its closed configuration;

FIG. 3 of the drawings is a perspective view of the electronic learning aid device of the present invention in its closed configuration;

FIG. 4 of the drawings is a front elevational view of the electronic learning aid apparatus of the present invention in its open configuration specifically illustrating the portable handheld module in its installed configuration;

FIG. 5 is a front elevational view of the electronic learning aid apparatus of the present invention specifically showing the portable handheld module removed; and

FIG. 6 of the drawings illustrates the installation and removal of the portable handheld module of the present invention specifically shown in its partial uninstalled configuration.

### DETAILED DESCRIPTION OF THE DRAWINGS

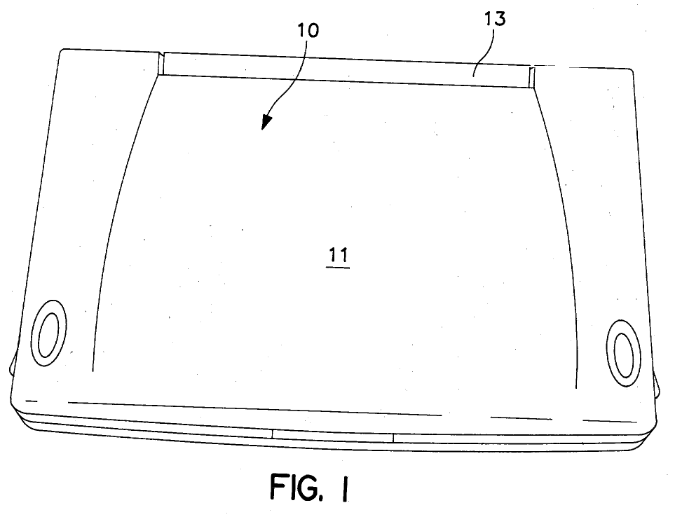

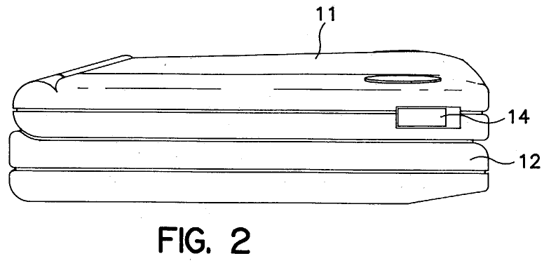

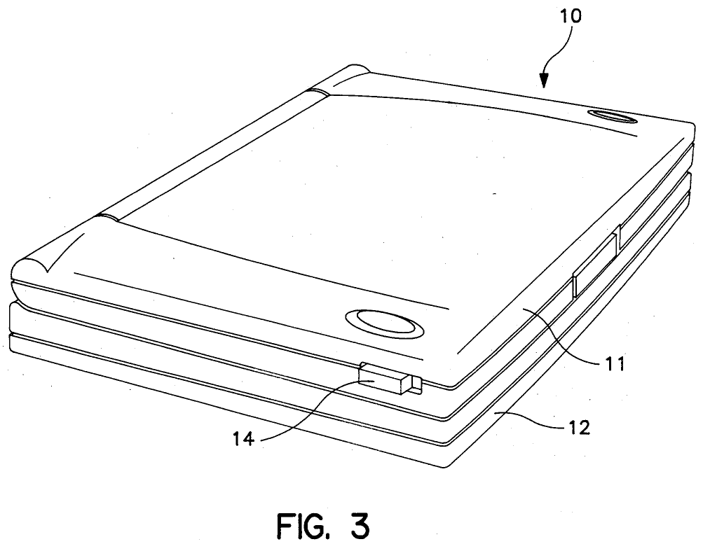

FIGS. 1 through 3 of the drawings illustrate the electronic learning aid apparatus 10 of the present invention specifically showing cover member 11 overlapping the base portion 12 in an open configuration, such movement being facilitated by hinge 13. Release tab 14 serves to unlock cover member 11 from base member 12 permitting it to be alternatively opened and locked in a closed position. While the electronic learning aid apparatus illustrated is of an overall clamshell housing design, the present invention may be executed in devices having other exterior designs as the present invention is not deemed limited to the illustrated external housing design.

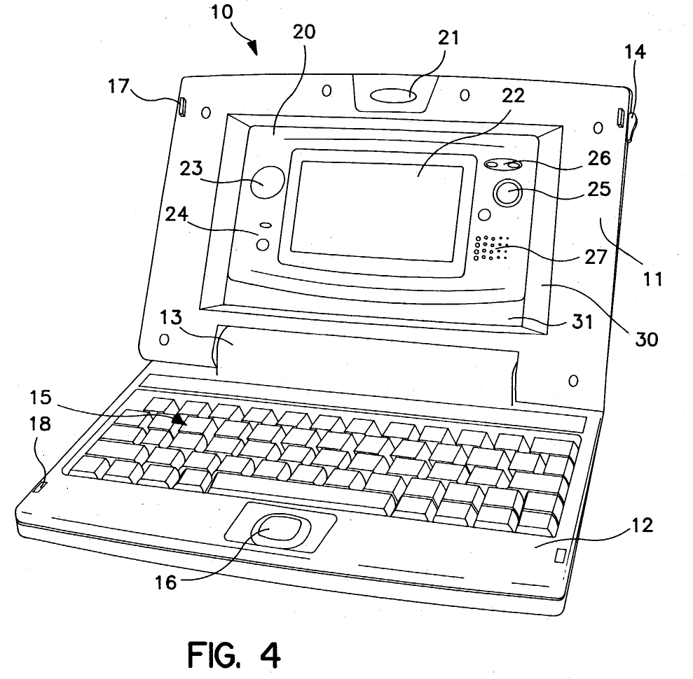

FIG. 4 of the present invention illustrates the present electronic learning aid apparatus in its open configuration. Cover member 11 is shown in its substantially upright position moved from a closed to an open position by operation of hinge 13. Release button 14 and locking tabs 17 are shown positioned on the upper portion of cover member 11 such that locking tab 17 engages with opening 18 positioned in base member 12 when cover member 11 is closed so as to maintain the unit in a substantially closed configuration. Lower member 12 is shown including input keyboard 15 and cursor control button 16.

Cover member 11 is shown having removable portable handheld game unit 20 in its installed position. Bezel 30 surrounds the recess into which handheld game unit 20 is placed which is itself held in place by operation of pivoting socket 31 and locking tab 21. Handheld game unit 20 includes an LCD display screen 22 together with input controls 23 through 25. In the present embodiment, input control 23 is a cursor control; buttons 24 provide set up and on/off control; button 26 controls the contrast on LCD 22; and buttons 25 serve to enter information and clear the display. Speaker grill 27 is shown provided on member 20 for purposes of permitting sound to emanate from a speaker element positioned underneath.

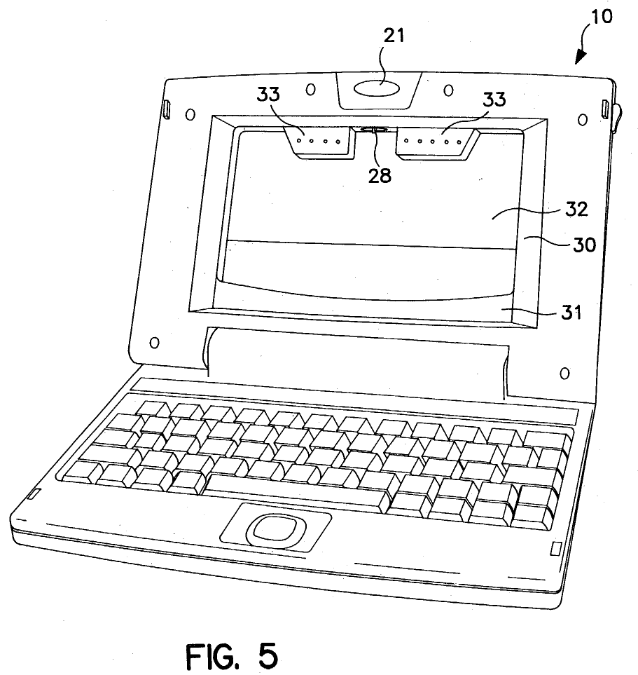

FIG. 5 of the drawings specifically illustrates the electronic learning aid 10 of the present invention with handheld game unit 20 in its uninstalled configuration. Specifically, it can be seen that recess 32 is provided in cover member 11 for receipt of handheld game unit 20 in a manner such that cover member 11 may close flat with base member 12. Electrical contacts 33 are shown positioned within recess 32 which serve to provide electrical connection between base member 12 and removable handheld unit 20. Electrical contacts 33 in the embodiment illustrated comprise a plurality of metal spring-loaded pins which serve to abut and make electrical contact with metallic conductive contacts positioned on the rear facing surface of handheld unit 20, not shown. Handheld unit 20 is retained within cover member 11 by virtue of pivoting socket 31 and locking tab 28.

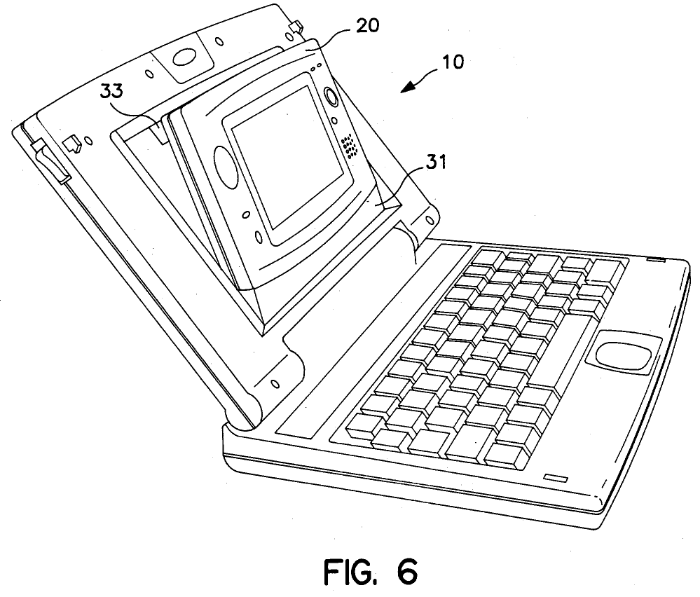

As further illustrated in FIG. 6 of the drawings, handheld unit 20 is installed by inserting the lower edge of handheld unit 20 into pivoting socket 31. The upper edge of handheld unit 20 is pivoted toward cover member 11 such that a recess within the top edge of unit 20 engages with locking tab 28 which may be alternatively engaged and released by virtue of release button 21. To remove handheld unit 20, locking button 21 is depressed thereby releasing the upper surface of unit 20 which may then be tipped forward and away from cover member 11. When clear of the upper portion of recess 32 the handheld unit 20 may be lifted free from socket 31. Socket 31 may be spring biased such that its normal position is biased away from recess 32 to thereby prompt unit 20 to move away from and out of recess 32. Alternatively, electrical contacts 33 may be constructed with sufficient spring loaded bias to prompt unit 20 away from and out of recess 32 such that it may be grasped manually and lifted free of socket 31.

In operation as illustrated in FIG. 4, the device of the present invention operates as a conventional electronic learning aid apparatus whereby graphical data is presented to the user on LCD 22; audible commands are presented to the user via speaker 27; and user inputs are accepted from the user via keyboard 15 and cursor control 16. In the preferred embodiment of the present apparatus substantially all of the electronic circuitry necessary for operation of the present invention resides within removable unit 20 such that electrical contacts 33 serve only to connect external keyboard 15 to the handheld unit 20. In that embodiment, batteries contained within removable unit 20 provide electrical power to the entire device. In an alternative embodiment of the present invention, additional electronic circuitry may be contained within base member 12 and or cover member 11 to provide enhanced functionality to device 10 when removable unit 20 is in its installed configuration. Examples of such additional functionality include, but are not limited to, electrical interfaces to such accessories as printers or external recording media or additional input devices such as an external mouse or the like. It is within the scope of the present invention to provide that controls 23 through 25 may or may not remain active when unit 20 is in its installed configuration depending upon the particular activity being executed and displayed on screen 22.

It is further provided by the present invention that removable unit 20 automatically detects whether it is in its installed or uninstalled configuration for the purpose of, in one embodiment, causing one series of activities or program content to be accessible to the user when the unit is in its installed configuration and a different, additional, or related set, of activities and/or content to be accessible to the user when unit 20 is in its uninstalled configuration.

Accordingly, when it is in a detached configuration handheld unit 20 functions as a stand-alone fully functional device, and serves to provide primarily entertainment activities to the user. Of course, the present invention may be adapted to various other types and/or forms of activities wherein a first set of activities is accessible to the user when the removable device is in an installed configuration in the base unit and wherein a second set of activities is accessible to the user when the removable device is in its uninstalled configuration.

Moreover, to provide balance between the educational activities and content of the present invention and the game play/entertainment content of the present invention provided by the removable unit 20, the system of the present invention functions so as to provide that the functionality and/or properties of existing entertainment activities and games is increased and/or that one or more additional games are made available to the user, only after certain educational activities are played such as when the unit is in its installed configuration. Alternatively, such additional functionality may be provided when certain competency or proficiency is achieved, such as by reaching a certain score or grade, or a certain elapsed time of play of the educational activities is achieved, as determined by the educational programming in the unit.

For example, to further enhance the utility of the present invention, the play of the entertainment activities and the play of the educational activities are configured to interact with each other. It is contemplated that one or more of the game activities will include “characters” or “performers” who are manipulated by the user as an object of the game play. Examples of such typical game activities include racing games where the goal is for the user to “drive” his or her car to victory, maze games where the goal is to traverse a maze in the quickest time, sporting games such as golf or baseball where the object is to hit the ball the farthest, and conquest games where the object is for the user's character to attack, pass by or engage others. To promote the use of the educational play of the unit, it is contemplated that a given character or performer being manipulated by the user will acquire greater skill and power as the user spends more time using the educational activities of the unit and/or answers more questions presented by the educational content activities correctly. By way of example, as the user spends more time playing the educational activities or is able to answer more questions correctly, the racecar may get faster or the character may get stronger.

It is further contemplated that as a result of spending more time using the educational activities content additional “levels” within entertainment activities, or even new activities altogether, may be made available to the user. For example, new race courses or mazes may become accessible to the user or new functionality, such as providing for head to head play between two separate removable game modules may be offered when the user reaches a certain total elapsed time of play on the educational activities or reaches a certain level of proficiency therein. In such a manner, the child gets both the educational value and benefit, as well as the entertainment value from the electronic learning aid and is encouraged to not simply discard the base unit and use the handheld unit for its pure entertainment value.

Alternatively, it is deemed within the scope of the present invention to provide that removable unit 20 may on its own provide certain review, supplemental and/or original educational content to the user in order to permit the user to continue and/or initiate game play. For example, the unit may present one or more math problems to the user which have to be answered correctly before the child can use the games within removable unit 20. These math problems may, for example, be a function of and or supplemental to the math programming which the unit detects as having been access by the child when removable unit 20 is in its installed configuration.

According to the present invention, a single device serves the dual purpose of both educating and entertaining the child user without the need to purchase multiple electronic devices which devices in fact, in today's state of electrical development comprise what is essentially the same level of technology.

The foregoing description and drawings merely explain and illustrate the invention and the invention is not limited thereto, except insofar as the appended claims are so limited as those skilled in the art who have the disclosure before them will be able to make modifications and variations therein without departing from the scope of the invention.

What is claimed is:

1. A dual purpose electronic educational entertainment apparatus, the apparatus comprising:
a base unit having at least one user input device;
a removable unit having at least one user input device and a visual display;
the base unit further including a receptacle for the removable receipt of the removable unit towards the base unit and removable unit operating together as a unit when the removable unit is in its installed configuration and wherein the removable unit may operate separate and independent of the base unit when the removable unit is either in its installed or uninstalled configuration.

2. The apparatus according to claim 1 wherein a first set of activities is accessible to the operator when the removable unit is in its installed configuration and wherein a second set of activities is accessible to the operator when the removable unit is in its uninstalled configuration.

3. The apparatus according to claim 2 wherein the first set of activities are primarily educational in nature.

4. The apparatus according to claim 2 wherein the second set of activities are primarily entertainment in nature.

5. An electronic educational entertainment apparatus for presenting to a child both educational activities and entertainment activities, the apparatus comprising:
a base unit having at least one user input device;
a removable unit having at least one user input device, a visual display, memory for storing both a first and a second set of activities, a detector for indicating that it is either in the installed or uninstalled configuration, and control circuitry for enabling only one of the first or second sets of activities when the removable unit is in the installed configuration;
the base unit further including a receptacle for accepting receipt of the removable unit towards the base unit and removable unit operating together as a unit when the removable unit is in its installed configuration.

6. The apparatus according to claim 5 wherein the first set of activities are primarily educational in nature.

7. The apparatus according to claim 5 wherein the second set of activities are primarily entertainment in nature.

8. A dual purpose electronic educational entertainment apparatus, the apparatus comprising:
a base unit having at least one user input device;
a removable unit having at least one user input device and a visual display;
the base unit further including a receptacle for the removable receipt of the removable unit towards the base unit and removable unit operating together as a unit, the removable unit visual display being viewable and usable when the removable unit is in its installed configuration, and wherein the removable unit may operate separate and independent of the base unit when the removable unit is in its uninstalled configuration.
